(19) United States
(12) Patent Application Publication
(10) Pub. No.: US 2005/0025932 A1
(43) Pub. Date: Feb. 3, 2005

(54) Indoor and outdoor shrub, tree & plant pruning and trimming canvas drop cloth

(76) Inventors: James Joseph Molino, Holbrook, NY (US); LauraAnn Molino, Holbrook, NY (US)

Correspondence Address: James J. Molino, 31 Jenna Court, Holbrook, NY, 11741, US

(21) Appl. No.: 10/631,429

(22) Filed: Jul. 31, 2003

(51) Int. Cl. B32B 3/10

(52) U.S. Cl. 428/102; 428/131; 428/136

(57) ABSTRACT

An indoor and outdoor plant, shrub & tree pruning and trimming canvas drop cloth, simplistic in design, shaped in a square with a single hole in the center and a single slit from the outer edge leading to the hole. The indoor and outdoor pruning and trimming canvas drop cloth fits around the base of most large indoor and outdoor potted plants. The indoor and outdoor pruning and trimming drop cloth allows protection of all interior floors and exterior wood decks, cement or brick patios or walkways, etc. when pruning, changing topsoil or transferring a plant from one pot to another. The indoor and outdoor pruning and trimming drop cloth also protects all types of ground covering, such as; mulch, topsoil, gravel and stone when trimming or pruning shrubs or trees. In all uses, the drop cloth's functions are the same. Simply, wrap the indoor and outdoor pruning and trimming drop cloth around any large indoor or outdoor potted plant, shrub, flower or tree and begin pruning, trimming, changing soil or transferring a plant from pot to another. When task is complete, the drop cloth has captured all the debris, which then allows for quick and easy cleanup. Just fold the drop cloth and discard debris in a garbage pail or bag.

### BACKGROUND OF THE INVENTION

1. Field of the Invention

The present invention relates generally to protect indoor flooring and outdoor wood decks, cement or brick patios or walkways, etc. from pruning, trimming, topsoil changes or transferring a plant from one large pot to another. This invention also protects expensive ground coverings, such as; mulch, gravel, stone or topsoil from trimming or pruning plants, shrubs or trees.

2. Description of Related Art

Removable landscaping tarps or ground covers have been designed for outdoor use only on shrubs and trees. For example, U.S. Design Pat. No. 6,090,466 issued to Kartisek illustrates a large gardening aid having a pouch and ring pulls needed for large quantities of clippings. There is no suggestion of any indoor or outdoor use on large potted plants. The ring pulls, rope and pouch suggest that the tarp is used for large trimming jobs. The extra time and material needed to add the pouch and ring pulls increases the manufacturing cost. The simple design of the instant invention avoids these costs without compromising its intended use.

U.S. Design Pat. No. 6,128,852 issued to Hansen illustrates a landscaping tarp which has a flexible elastic sheathing in the center to tightly wrap around any shrub or small tree. The center also has three pairs of Velcro loop connector hooks to pull the tarp closed for carrying. A flap with two Velcro strips is used to keep the cloth closed around the shrub or tree. There is no suggestion of any indoor or outdoor use on large potted plants. The extra time and material needed to add the sheathing material, flap and Velcro loop connectors and strips increases to the manufacturing cost. The simple design of the instant invention avoids these costs without compromising its intended use.

The Indoor and Outdoor Plant, Shrub & Tree Pruning and Trimming Canvas Drop Cloth is the most simplistic version of the prior and related art. It provides the consumer with an indoor and outdoor pruning and trimming drop cloth which is inexpensive and affective. The Indoor and Outdoor Plant, Shrub & Tree Pruning and Trimming Canvas Drop does not have any ropes, Velcro loop connectors or strips, pouches, flaps or pulling rings to keep it simple, affordable and to keep manufacturing costs down.

### SUMMARY OF THE INVENTION

The Indoor and Outdoor Plant, Shrub & Tree Pruning and Trimming Canvas Drop Cloth according to the instant invention is a canvas drop cloth, square in design with a single slit from the edge to a hole in the middle of the cloth. All edges are stitched to prevent tearing or fraying. It provides protection to all indoor flooring and outdoor surfaces when pruning, trimming or changing topsoil of indoor or outdoor large potted plants. It also provides protection to all ground covering, such as; gravel, mulch, topsoil or stones when pruning or trimming plants, shrubs or trees.

It is a further object of the invention to provide an indoor and outdoor plant, shrub & tree pruning and trimming canvas drop cloth which retains debris and provides a tool for quick and easy clean-up.

Further still, most importantly, another object of the invention is to provide an indoor and outdoor plant, shrub & tree pruning and trimming canvas drop cloth that is low in manufacturing costs, inexpensive for the consumer and easy to use.

Another object of the invention is to provide an indoor and outdoor plant, shrub & tree pruning and trimming canvas drop cloth that is easy to deploy and easy to store.

Another object of the invention is to provide an indoor and outdoor plant, shrub & tree pruning and trimming canvas drop cloth that is light in weight and easy to carry.

Another object of the invention is to provide an indoor and outdoor plant, shrub & tree pruning and trimming canvas drop cloth that is made of a material that can be easily cleaned with the use of a washing machine.

Another object of the invention is to provide a indoor and outdoor plant, shrub & tree pruning and trimming canvas drop cloth which has multiple functionalities. The indoor and outdoor plant, shrub & tree pruning and trimming canvas drop cloth may be used for its intended use with plants, flowers, shrubs, trees, large indoor potted plants and outdoor potted plants, but also may be used for painting or staining or for any other purpose for which a drop cloth may be put to use.

These and other objects of the present invention will become readily apparent upon further view of the following specifications and drawings.

### BRIEF DESCRIPTION OF THE DRAWINGS

FIG. 1 is an overall view of the Indoor and Outdoor Plant, Shrub & Tree Pruning and Trimming Canvas Drop Cloth which shows the simple design while not compromising the function ability of its intended use.

FIG. 2 is a perspective view of the Indoor and Outdoor Plant, Shrub & Tree Pruning and Trimming Canvas Drop Cloth about the base of a large indoor potted plant, tree or flower on an oak wood floor that is protected by the canvas drop cloth.

FIG. 3 is two completed views (3A & 3B) of the Indoor and Outdoor Plant, Shrub & Tree Pruning and Trimming Canvas Drop Cloth that has been used indoors to transfer a plant, which can also be a small tree or flower, from one large pot to another, while protecting the indoor floor.

FIG. 4 is a similar reference view of the Indoor and Outdoor Plant, Shrub & Tree Pruning and Trimming Canvas Drop Cloth showing its exterior use as being the same as FIG. 2 & FIG. 3 while protecting all wood decks, cement or brick patios or walk ways.

FIG. 5 is an illustrative view of the Indoor and Outdoor Plant, Shrub & Tree Pruning and Trimming Canvas Drop Cloth about the base of an outdoor shrub, which can also be a plant, flower or tree, that is being trimmed.

FIG. 6 Depicts the view of the Indoor and Outdoor Plant, Shrub & Tree Pruning and Trimming Canvas Drop Cloth in the first of three steps of the folding process after trimming, pruning, changing topsoil or transferring a plant from one large pot to another.

FIG. 7 is a view of the Indoor and Outdoor Plant, Shrub & Tree Pruning and Trimming Canvas Drop Cloth in the second step of the folding process which follows FIG. 6.

FIG. 8 is a view of the Indoor and Outdoor Plant, Shrub & Tree Pruning and Trimming Canvas Drop Cloth in the third and final step of the folding process which follows FIG. 7.

FIG. 9 is a front view of the Indoor and Outdoor Plant, Shrub & Tree Pruning and Trimming Canvas Drop Cloth in the final step following FIG. 8.

### DETAILED DESCRIPTION OF THE PREFERRED EMBODIMENTS

The present invention is directed towards a simple design of an indoor and outdoor plant, shrub & tree pruning and trimming canvas drop cloth that wraps around any large interior or exterior potted plants, as well as most shrubs & trees. My objective in the development of this invention is to protect all interior floors and all exterior surfaces while also protecting expensive ground coverings from dirt, twigs, dead leaves and all trimmings. The facts above and the goal to provide the consumer with a light weight, easy to deploy, machine washable, easy to use and very affordable product will be explained in the following embodiments.

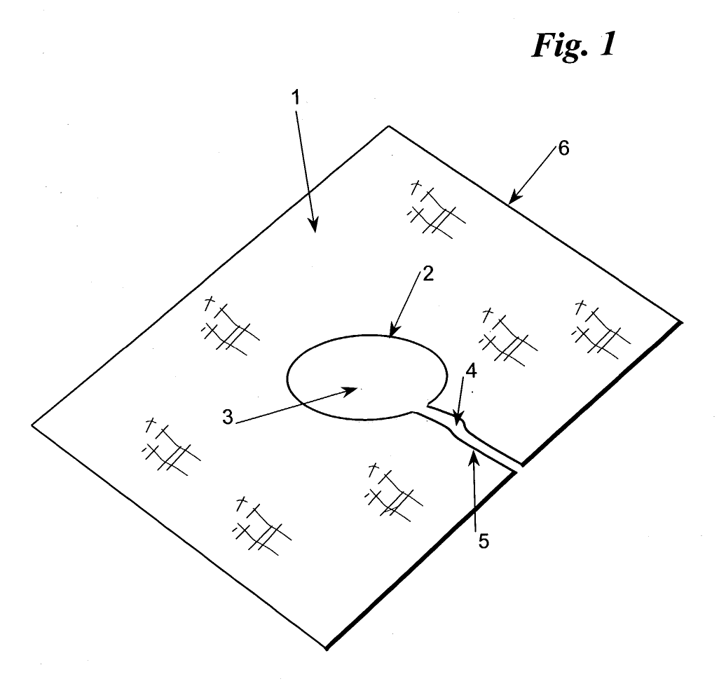

FIG. 1 shows the Indoor and Outdoor Plant, Shrub & Tree Pruning and Trimming Canvas Drop Cloth in its most simplistic design #1. The square cloth #1 has a round hole in the center #3 with a singular slit #4 from the outer edge #6 to the edge of the circle #2. The edge of both slits #5 will allow you to completely wrap the cloth #1 around any large indoor, outdoor pot or any exterior plant, tree, shrub or flower.

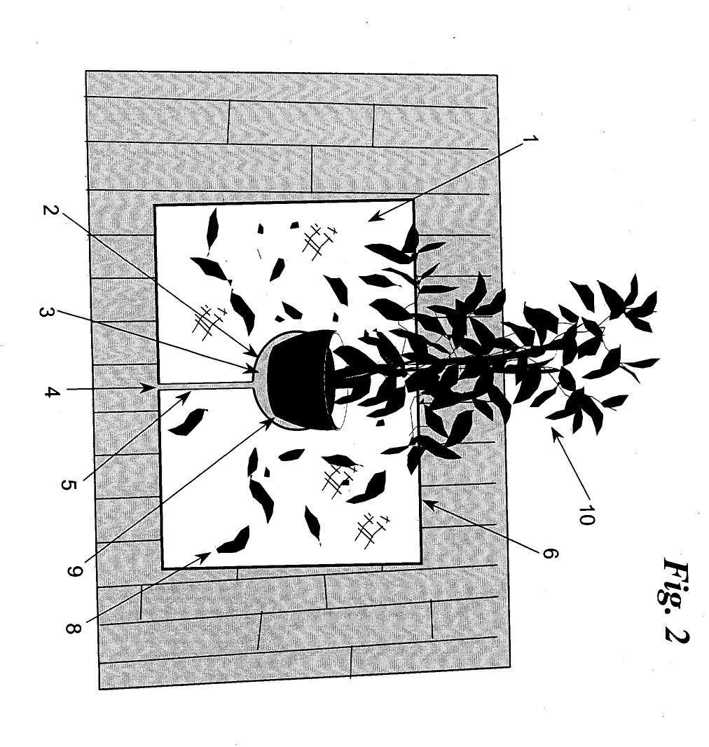

FIG. 2 shows a large indoor pot #9 with the Indoor and Outdoor Plant, Shrub & Tree Pruning and Trimming Canvas Drop Cloth #1 wrapped around it. To close the space #4, grab the edges of both slits #5 and pull tightly around the large indoor pot #9. The large plant #10, which can be a tree or flower, sits in the large indoor pot #9 ready to be trimmed or pruned while protecting the interior floor. When the pruned or trimmed leaves fall #8, the specially designed drop cloth #1 captures all the debris without effecting the interior floor.

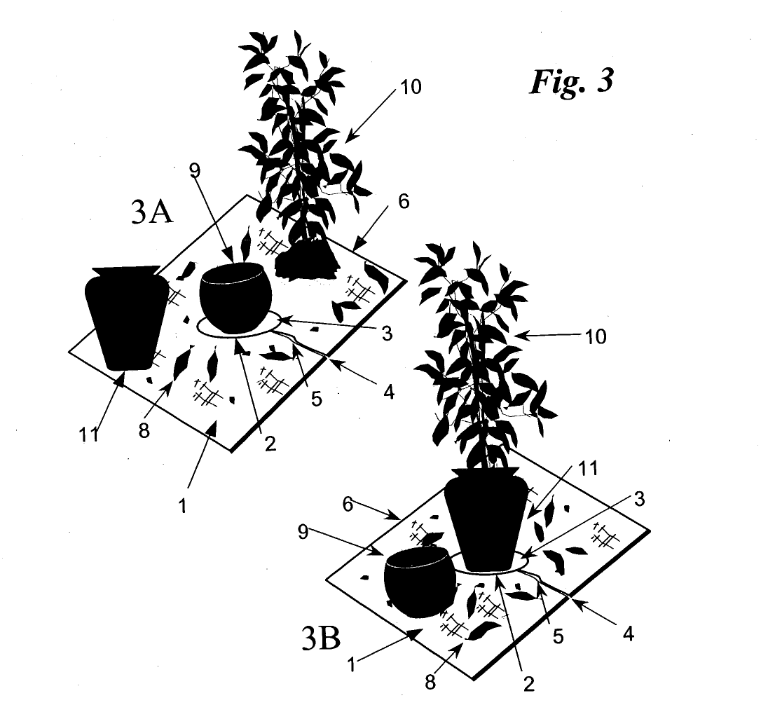

FIG. 3 shows a two stage drawing of the Indoor and Outdoor Plant, Shrub & Tree Pruning and Trimming Canvas Drop Cloth. 3A shows the Indoor and Outdoor Plant, Shrub & Tree Pruning and Trimming Canvas Drop Cloth #1 with a large empty pot #9 sitting in the center #3. The large plant #10 was removed from the large pot #9 and placed to the right of the center #3 of the drop cloth #1. The large replacement pot #11 sits to the left of the center #3 of the cloth #1. 3B shows The large empty pot #9 removed and placed to the left of the center #3 of the drop cloth #1. The large replacement pot #11 is now placed in the center #3 of the drop cloth #1. The previously removed plant #10, 3A is now placed into the new pot #11, 3B located in the center #3 of the drop cloth #1, 3B. This illustration demonstrates how all indoor flooring is protected while transferring a plant, flower or tree from one large pot to another.

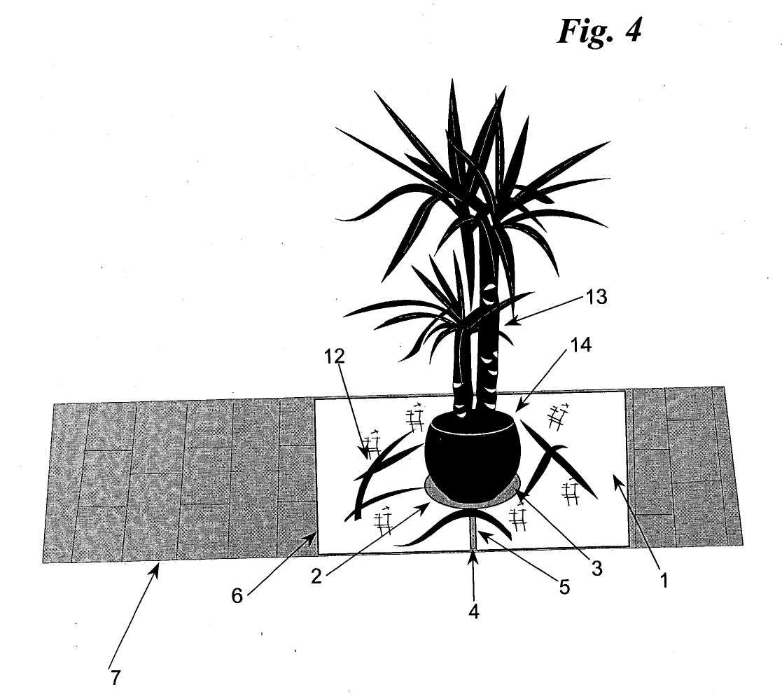

FIG. 4 shows the Indoor and Outdoor Plant, Shrub & Tree Pruning and Trimming Canvas Drop Cloth #1 sitting on an exterior brick walkway #7. To close the space #4, grab the edges of both slits #5 and pull tightly around the large outdoor pot #14. The large plant #13, which can be a tree, shrub or flower, sits in the large outdoor pot #14 ready to be trimmed or pruned while keeping the debris off of the brick walkway #7. When the pruned or trimmed leaves fall #12, the specially designed drop cloth #1 captures all the debris without effecting the brick walkway #7

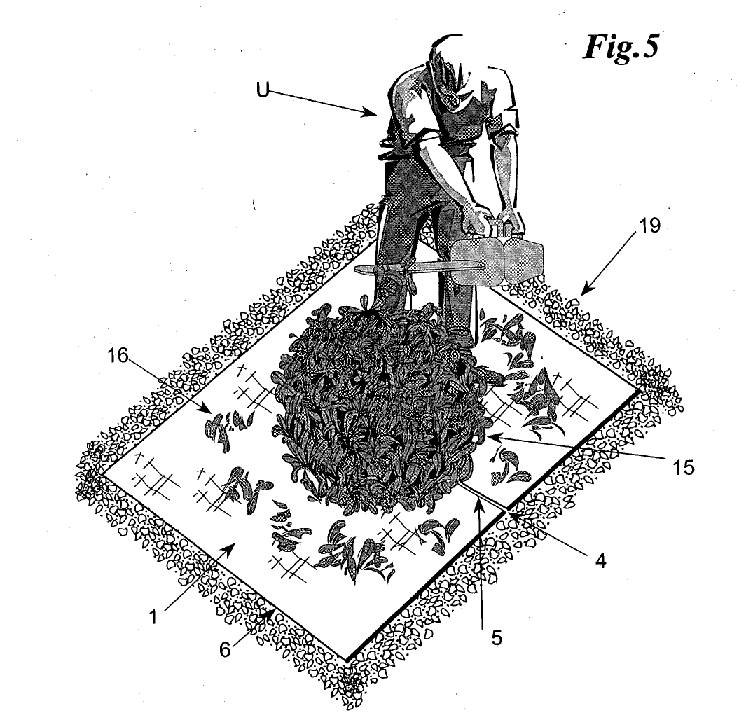

FIG. 5 shows the Indoor and Outdoor Plant, Shrub & Tree Pruning and Trimming Canvas Drop Cloth #1 wrapped around an exterior bush #15. To close the space #4, grab the edges of both slits #5 and pull tightly around the exterior bush #15. The exterior bush #15, which can be a tree, plant or flower, sits on a bed of gravel #19, which can be mulch, stones, topsoil or grass, while a user U is trimming or pruning the bush #15. When the pruned or trimmed leaves fall #16, the specially designed drop cloth #1 captures all the debris without mixing in with the gravel #19.

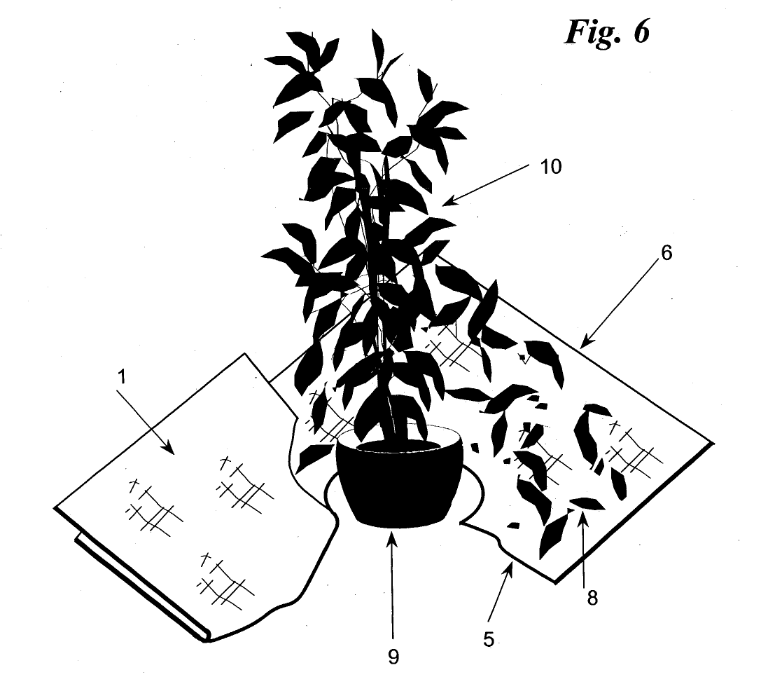

FIG. 6 shows the Indoor and Outdoor Plant, Shrub & Tree Pruning and Trimming Canvas Drop Cloth #1 wrapped around a large interior potted plant #9 & #10, which can be an interior or exterior shrub, tree or flower. FIG. 6 also shows the first step of the folding process after pruning, trimming, changing topsoil or transferring a plant, tree or flower from one large pot to another. Grab the left side edge #6 of the drop cloth #1, and fold towards the back of the cloth and gently place down over the fallen debris #8. The debris #8 is now secured between the top and bottom of the left side of the canvas drop cloth #1.

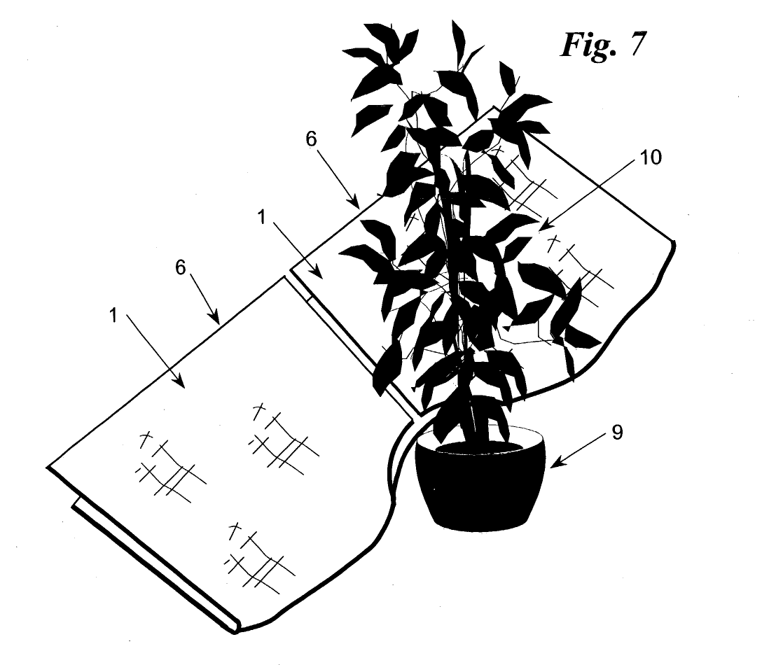

FIG. 7 shows the Indoor and Outdoor Plant, Shrub & Tree Pruning and Trimming Canvas Drop Cloth #1 partially folded around a large interior potted plant #9 & #10, which can be an interior or exterior shrub, tree or flower. FIG. 7 also shows the second step of the folding process after pruning, trimming, changing topsoil or transferring a plant, tree or flower from one large pot to another. Following FIG. 6, grab the right side edge #6 of FIG. 7 of the drop cloth #1, and fold towards the back of the cloth and gently place down over the fallen debris. The debris is now secured between the top and bottom of both sides of the canvas drop cloth #1.

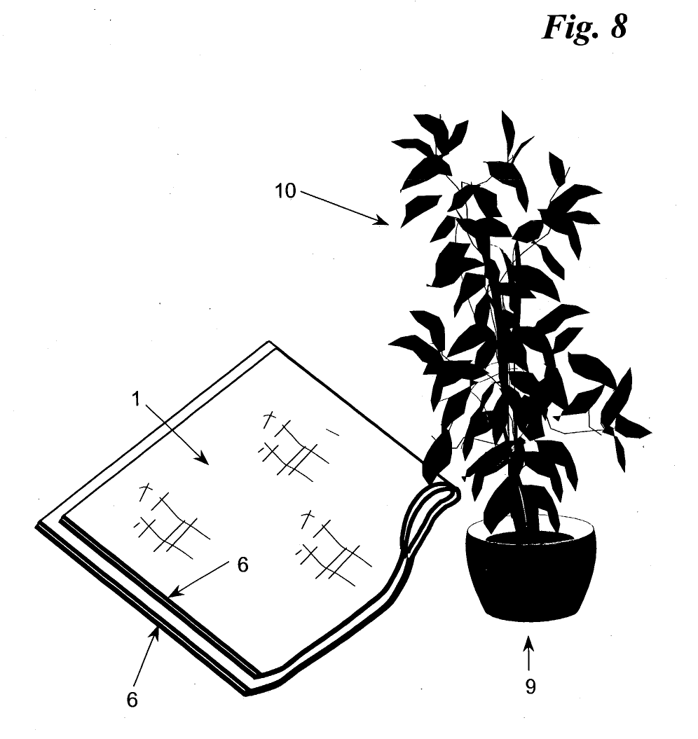

FIG. 8 shows the Indoor and Outdoor Plant, Shrub & Tree Pruning and Trimming Canvas Drop Cloth #1 in its final folding stage by the large interior potted plant #9 & #10, which can be an interior or exterior shrub, tree or flower. Following FIG. 7, grab the right side edge #6 of the drop cloth #1, and fold towards the left side of the cloth and gently place down over the already folded side of the canvas drop cloth.

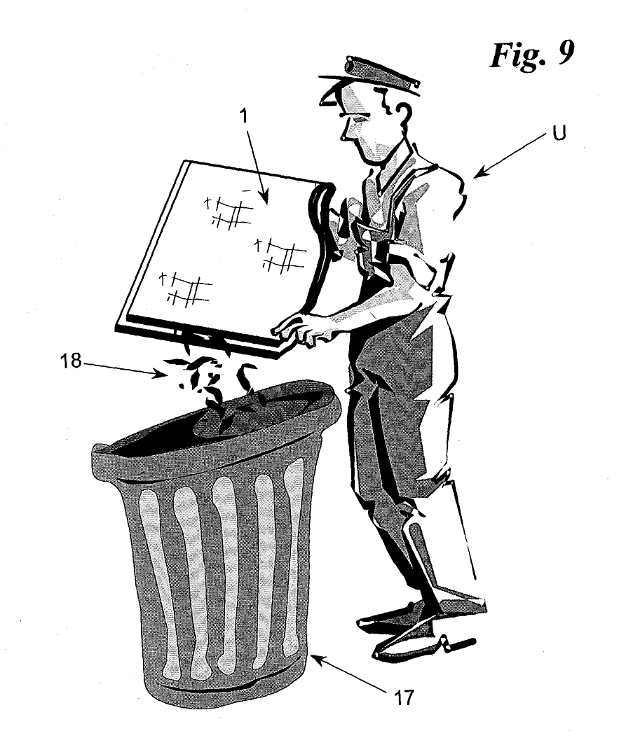

FIG. 9 shows the Indoor and Outdoor Plant, Shrub & Tree Pruning and Trimming Canvas Drop Cloth #1 in its completed folded stage being held over a garbage pail #17 as it unfolds while being shaken by a user U (not illustrated, but suggested) to allow all of the debris #18 to fall into the garbage pail #17.

1. An Indoor and Outdoor Plant, Shrub & Tree Pruning and Trimming Canvas Drop Cloth used to protect all interior floors and exterior wood decks, cement or brick patios or walkways, mulch, stones, gravel or topsoil when pruning, trimming, changing topsoil or transferring a plant from one large pot to another comprising of:
a canvas cloth material square in design, all edges stitched;
the material further comprises of a single slit from the outer edge leading to the centrally located hole in the center.

2. The Indoor and Outdoor Plant, Shrub & Tree Pruning and Trimming Canvas Drop Cloth according to claim 1, where in said material is canvas.

3. The Indoor and Outdoor Plant, Shrub & Tree Pruning and Trimming Canvas Drop Cloth according to claim 1, wherein said material is stitched on all edges.

4. The Indoor and Outdoor Plant, Shrub & Tree Pruning and Trimming Canvas Drop Cloth according to claim 1, wherein said is the most simplistic in design.

5. The Indoor and Outdoor Plant, Shrub & Tree Pruning and Trimming Canvas Drop Cloth according to claim 2, wherein said canvas material is machine washable.

6. The Indoor and Outdoor Plant, Shrub & Tree Pruning and Trimming Canvas Drop Cloth according to claim 2, wherein said canvas drop cloth is light weight and flexible.

7. The Indoor and Outdoor Plant, Shrub & Tree Pruning and Trimming Canvas Drop Cloth according to claim 4, wherein said canvas drop cloth is inexpensive to manufacture.

8. The Indoor and Outdoor Plant, Shrub & Tree Pruning and Trimming Canvas Drop Cloth according to claim 6, wherein said canvas drop cloth is easy to deploy and store.
